(19) United States
(12) Patent Application Publication
(10) Pub. No.: US 2018/0325073 A1
(43) Pub. Date: Nov. 15, 2018

(54) PET DEFECATION APPARATUS

(71) Applicant: RAONTEC CO., LTD., Daegu (KR)

(72) Inventor: Young Do CHOI, Daegu (KR)

(21) Appl. No.: 15/739,140

(22) PCT Filed: Jul. 8, 2015
(86) PCT No.: PCT/KR2015/007041

§ 371 Date: Dec. 21, 2017

(51) Int. Cl. A01K 1/01

(52) U.S. Cl. CPC A01K 1/0117; A01K 1/0125

(57) ABSTRACT

The present invention relates to a pet defecation apparatus and, more particularly, to a pet defecation apparatus which enables a series of processes for pet excretion disposal using a defecation pad, such as rolling up and packing the defecation pad to which excretion is added, and collecting and moving the defecation pad to a designated position, to be easily performed by means of automation.

### TECHNICAL FIELD

The present invention relates to a pet defecation apparatus and, more particularly, to a pet defecation apparatus capable of enabling easy disposal of excreta of a pet by automating a series of processes for rolling and wrapping a waste pad soiled with the excreta and collecting the waste pad to a designated position.

### BACKGROUND ART

A large number of people around the world have pets, and over ten million Koreans own pets. The World Future Society (USA) predicted in 1999 that the world population would stop growing and, instead, pets will be greatly increased starting in 2035 (Heeyeon Kim, July 2004).

Such prediction is based on the fact that the problems of loneliness and human alienation have become serious due to increases in elderly people, unmarried people, and nuclear families and pets are regarded as companions like family members or friends in human lives, i.e., companion animals.

As the number of people who own pets is continuously increased, the related market is being diversified and subdivided. For example, animal hospitals, pet food providers, pet product shops, online pet product shopping malls, etc. are rapidly increased and, these days, the pet-related industry expands to pet cafes, pet insurance, pet care centers, custom-made pet dress shops, etc. and exerts a considerable influence on other industries.

However, an indoor living environment is unavoidably contaminated by hairs, excreta, etc. physiologically caused when raising a pet. Particularly, disposal of the excreta is not a mild problem even for an owner who treasures his or her pet.

In addition, since ammonia, gaseous castor, mercaptan, amines, etc. generated from the excreta not only cause odors but also are harmful to humans, disposal of the excreta should be performed within a short time after elimination to maintain a clean living environment. As such, proper disposal of the excreta is quite important.

Although the owner tries to train the pet in many ways to eliminate only in a designated area such as a restroom or bathroom, the pet which has elimination habits different from those of people who have ability to think may not easily eliminate only in an area desired by the owner.

Even when the pet is trained to eliminate only in a designated potty area, lots of toilet paper and water are wasted for disposal of the excreta and the disposal process is not easy.

To solve the above problems, a variety of diapers, waste pads, etc. for pets are sold by pet product shops, online pet product shopping malls, etc.

FIG. 1 is a perspective view showing the structure of a conventional waste pad P for a pet. Mostly, the waste pad p has a size of a certain width and length and absorbs liquids (e.g., urine) well. Thus, if the waste pad p is previously placed in a potty area to allow the pet to eliminate thereon, disposal of excreta may be enabled without using toilet paper and water.

That is, in the excreta dropped on the waste pad p due to elimination of the pet, urine may be absorbed by the waste pad p and feces may be wrapped with the waste pad p by rolling the waste pad p into a scroll shape, thereby enabling easy disposal of the excreta.

However, the process of manually rolling and wrapping the waste pad p soiled with the urine and feces not only causes user inconvenience but also is unhygienic because a body part of the user, e.g., a finger or palm, can be soiled with the excreta if the user is not careful.

### DISCLOSURE

### Technical Problem

Therefore, the present invention has been made in view of the above problems, and it is one object of the present invention to provide a pet defecation apparatus including a pad rolling device for rolling up a waste pad soiled with excreta, and a bag opening device for inserting the waste pad into a plastic bag, to automatically wrap the soiled waste pad.

It is another object of the present invention to provide a pet defecation apparatus further including a pad transporting device for receiving the plastic bag unrolled from a scroll-shaped plastic bag roll and transporting the waste pad wrapped in the plastic bag to a designated position, to easily take a waste box out of a main body to throw the wrapped waste pad contained therein into a trash can or the like.

### Technical Solution

In accordance with one aspect of the present invention, provided is a pet defecation apparatus including a main body for holding a waste pad to provide a potty area and enabling cooperative internal-external installation of constituent devices, a pad rolling device mounted in the main body to roll the waste pad soiled with excreta, into a scroll shape, a bag supplying device mounted in the main body to unroll a plastic bag roll to supply a plastic bag for wrapping the waste pad rolled by the pad rolling device, to a designated position, a bag opening device mounted in the main body to open a mouth of the plastic bag provided by the bag supplying device, in such a manner that the waste pad is insertable into the plastic bag, and a pad transporting device installed on a bottom of the main body to support the waste pad and the plastic bag and to transport the scroll-shaped waste pad wrapped in the plastic bag to a next position.

In accordance with another aspect of the present invention, provided is a pet defecation apparatus including a main body for holding a waste pad to provide a potty area and enabling cooperative internal-external installation of constituent devices, a pad rolling device mounted in the main body to roll the waste pad soiled with excreta, into a scroll shape, a bag supplying device mounted in the main body to unroll a plastic wrap roll to supply plastic wrap for wrapping the waste pad rolled by the pad rolling device, to a designated position, a pad wrapping device mounted in the main body to draw the plastic wrap supplied from the bag supplying device to place the plastic wrap at a designated position, and to wrap the scroll-shaped waste pad with the plastic wrap to transport the waste pad to a next position, and a pad transporting device installed on a bottom of the main body to support the waste pad and to transport the scroll-shaped waste pad to a next position.

In addition, the main body may have a sealed installation space for mounting and installing the constituent devices therein, and a waste table having a top opening and having a sufficient area for a pet to stand thereon may extend from a side of the main body.

Furthermore, the pad rolling device may include a pusher having a plurality of rolling arms used to roll the waste pad into a scroll shape and bent from opposite sides to face each other with an interval therebetween, and first racks and pinions for vertically lifting ends of the rolling arms at a designated timing in such a manner that the waste pad is gradually rolled by the pusher along a large orbit not to crush feces on the waste pad.

In addition, the bag supplying device may include a plastic bag roll or a plastic wrap roll including a plurality of tear-off plastic bags or a spool of plastic wrap, an unrolling roller for unrolling an end of the plastic bag roll or the plastic wrap roll to continuously supply the plastic bags or the plastic wrap to a designated position, one or more guide rollers for guiding the plastic bags or the plastic wrap unrolled by the unrolling roller, toward the bag opening device or the pad wrapping device, a plurality of feeding rollers rotating in contact with each other to draw the plastic bags or the plastic wrap guided by the guide rollers, to unroll the plastic bag roll or the plastic wrap roll and to supply the plastic bags or the plastic wrap toward the bag opening device or the pad wrapping device, and a cutter for cutting the plastic bags or the plastic wrap supplied toward the bag opening device or the pad wrapping device by the feeding rollers, into a single piece.

Furthermore, a container for accommodating the plastic bag roll or the plastic wrap roll therein may be provided at an upper part in the main body, and a drawer-type waste box having an internal space capable of accommodating the scroll-shaped waste pad wrapped in the plastic bag or with the plastic wrap may be further provided at an inner corner in the main body.

In addition, the bag opening device may include a lifting roller moved upward and downward in contact with an upper surface of the plastic bag to open the mouth of the plastic bag, by a rotator having ends rotatable upward and downward, and a second rack and pinion for rotating the ends of the rotator upward and downward.

Furthermore, the pad transporting device may include a first conveyor for initially transporting the waste pad placed on the waste table, toward the pad rolling device in such a manner that the waste pad is rolled into a scroll shape by the pad rolling device, a hitter for swinging a rotatable end thereof to hit the waste pad initially transported by the first conveyor, in the same moving direction to further transport the waste pad, and a second conveyor for ultimately transporting the waste pad wrapped after being inserted into the plastic bag by the hitter, into the waste box.

In addition, the pad transporting device may include a first conveyor for initially transporting the waste pad placed on the waste table, toward the pad rolling device in such a manner that the waste pad is rolled into a scroll shape by the pad rolling device, and a hitter for swinging a rotatable end thereof to hit the waste pad initially transported by the first conveyor, in the same moving direction to further transport the waste pad.

Furthermore, the pad wrapping device may include an accommodation pad provided on a bottom surface of the main body to prevent slippage of the plastic wrap supplied by the bag supplying device, and to accommodate therein the waste pad rolled into a scroll shape, a drawing member having an end bidirectionally rotatable in the main body to draw an unrolled end of the plastic wrap roll to place the plastic wrap on the accommodation pad, and a rotatable arm having a bidirectionally rotatable end to push the plastic wrap placed on the accommodation pad by the drawing member, to a side to wrap the waste pad and then to insert the waste pad into the waste box.

In addition, projections interfering with ends of a side of the waste pad to gradually roll up the waste pad may protrude by a predetermined length from inner sides of the ends of the rolling arms.

Furthermore, one or more pieces of adhesive tape adherable to a surface of the plastic bag may be provided at equal intervals on an external surface of the lifting roller.

In addition, a downward step for accommodating the waste pad dropped after being further transported by the hitter may be provided in a stepped shape at a side of the accommodation pad such that a part of the plastic wrap placed on the accommodation pad may sag downward to provide a recessed space capable of accommodating the scroll-shaped waste pad therein.

Furthermore, a push wheel capable of wrapping the scroll-shaped waste pad with the plastic wrap and pushing the waste pad toward the waste box may be coupled to the end of the rotatable arm.

### Advantageous Effects

As apparent from the foregoing, according to a pet defecation apparatus of the present invention, disposal of excreta of a pet may be enabled without manual handling of a user by automating an excreta disposal process for rolling a waste pad soiled with excreta, into a scroll shape, wrapping the waste pad in a plastic bag, and inserting the waste pad into a waste box. Since the waste pad is wrapped in the plastic bag, a variety of effects such as waterproofing, mothproofing, and deodorization may be achieved.

In addition, considering that animals eliminate at places having body odors of their own, when needed, a potty area of a pet may be easily changed without additional training by simply changing the location of the pet defecation apparatus of the present invention.

Furthermore, due to the above-described effects, efficiency of disposal of excreta may be increased and odors of the excreta may be prevented, thereby easily achieving a clean indoor living environment. In addition, the above advantages may encourage people to purchase products and thus the pet-related industry may be greatly developed and vitalized.

### DESCRIPTION OF DRAWINGS

FIG. 1 is a perspective view showing the structure of a conventional waste pad for a pet.

FIG. 2 is a side cross-sectional view showing an overall structure of a pet defecation apparatus according to the present invention.

FIG. 3 is a perspective view showing the structure of a pad rolling device in the pet defecation apparatus according to the present invention.

FIG. 4 is a perspective view showing the structure of a bag opening device in the pet defecation apparatus according to the present invention.

FIGS. 5 to 8 are cross-sectional views showing operation of the pet defecation apparatus according to the present invention.

FIG. 9 is a side cross-sectional view showing another embodiment of the pet defecation apparatus according to the present invention.

FIGS. 10 to 13 are cross-sectional views showing operation of the other embodiment of the pet defecation apparatus according to the present invention.

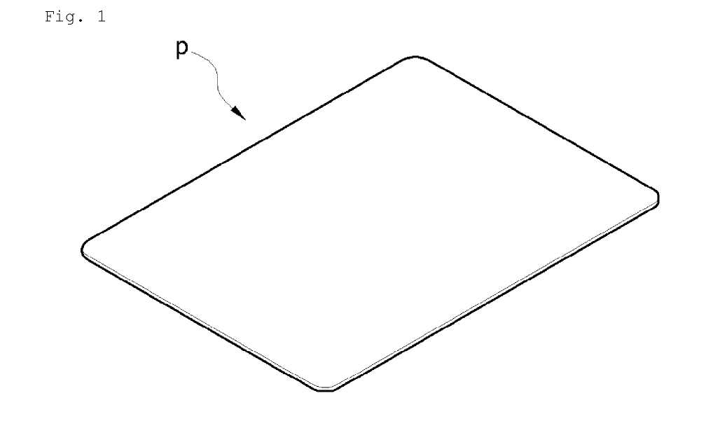

### EXPLANATION OF REFERENCE NUMERALS

A: potty, 1: main body, 1a: installation space
2: pad rolling device, 3: bag supplying device, 4: bag opening device
5: pad transporting device, 6: pad wrapping device, 11: waste table
12: container, 13: waste box, 14: controller
21: pusher, 22: first racks and pinions, 31: plastic bag roll
31′: plastic wrap roll, 31-1: plastic bag, 31′-1: plastic wrap
32: unrolling roller, 33: guide rollers, 34: feeding rollers
35: cutter, 41: lifting roller, 42: second rack and pinion
51: first conveyor, 52: hitter, 53: second conveyor
61: accommodation pad, 62: rotatable arm, 63: drawing member
121: lid, 211: rolling arms, 211-1: projections
221, 421: hinge arms, 410: adhesive tape, 411: rotator
611: downward step, 611a: recessed space, 621: push wheel

### BEST MODE

Hereinafter, the present invention will be described in detail by explaining embodiments of the invention with reference to the attached drawings in a manner sufficiently clear and complete for it to be carried out by a person skilled in the art.

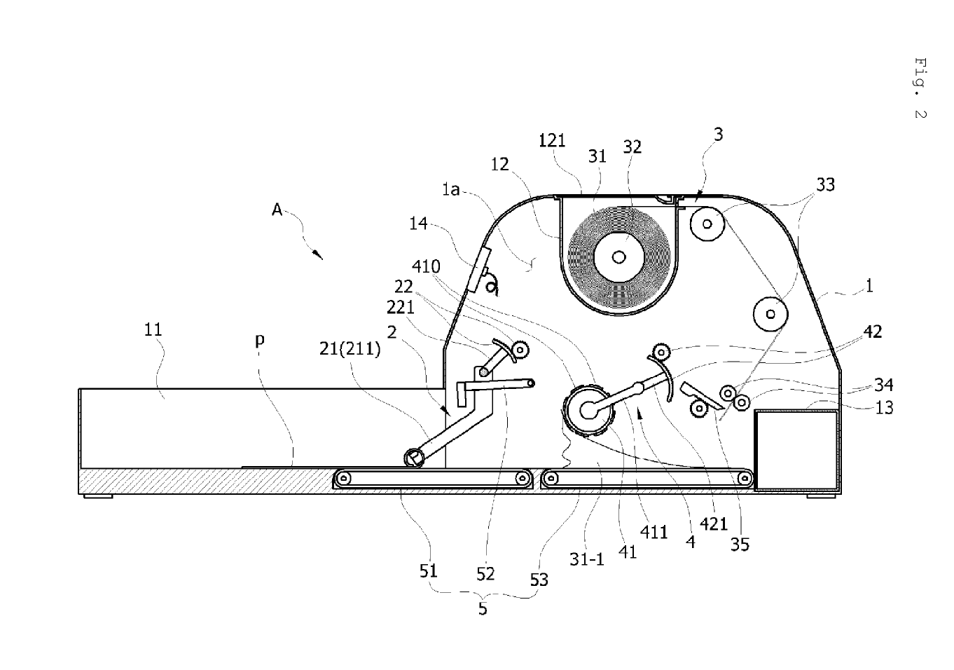

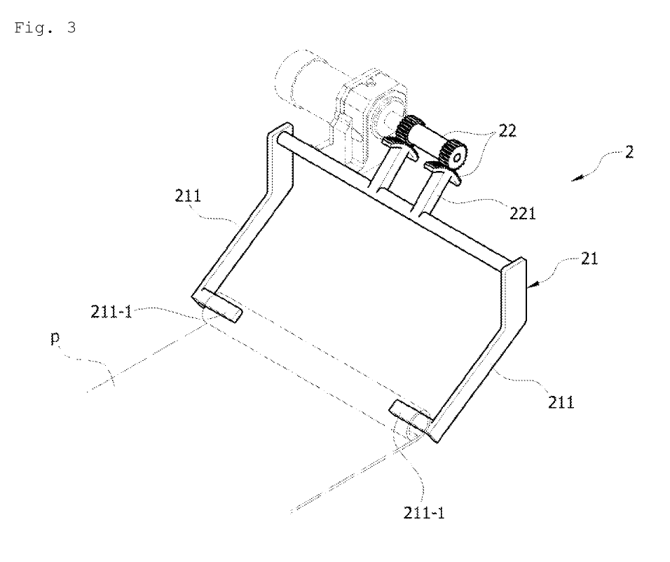

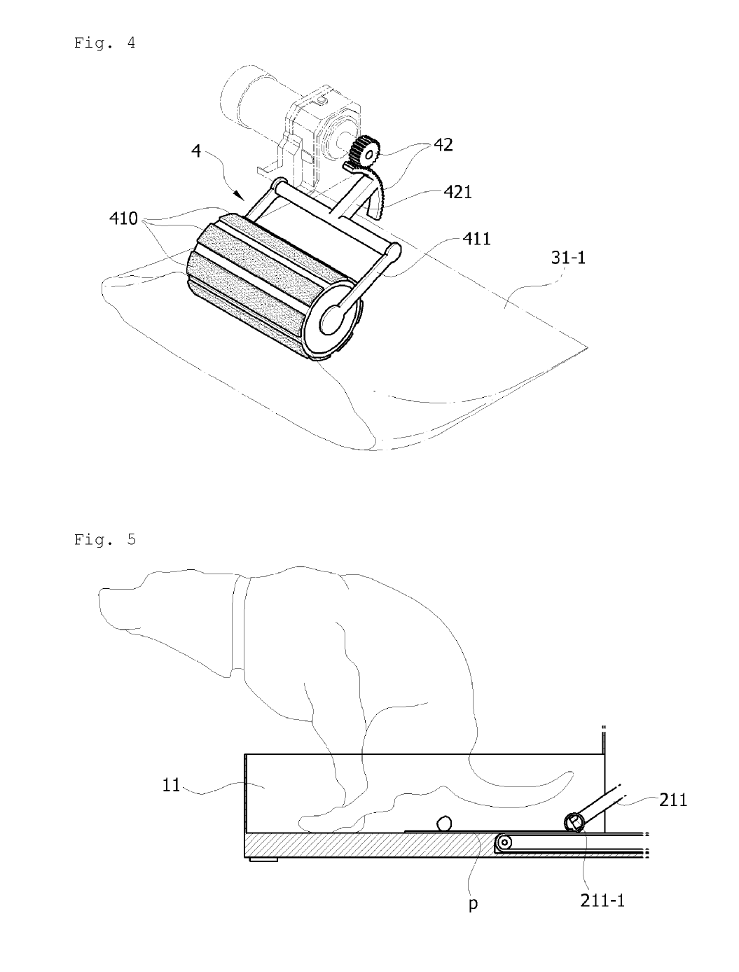

FIG. 2 is a side cross-sectional view showing an overall structure of a pet defecation apparatus A according to the present invention, FIG. 3 is a perspective view showing the structure of a pad rolling device 2 in the pet defecation apparatus A according to the present invention, FIG. 4 is a perspective view showing the structure of a bag opening device 4 in the pet defecation apparatus A according to the present invention, and FIGS. 5 to 8 are cross-sectional views showing operation of the pet defecation apparatus A according to the present invention.

As illustrated in FIG. 2, the pet defecation apparatus A according to the present invention includes a main body 1 for holding a waste pad p to provide a potty area and enabling cooperative internal-external installation of constituent devices, the pad rolling device 2 mounted in the main body 1 to roll the waste pad p soiled with excreta, into a scroll shape, a bag supplying device 3 mounted in the main body 1 to unroll a plastic bag roll to supply a plastic bag for wrapping the waste pad p rolled by the pad rolling device 2, to a designated position, the bag opening device 4 mounted in the main body 1 to open a mouth of the plastic bag provided by the bag supplying device 3, in such a manner that the waste pad p is insertable thereinto, and a pad transporting device 5 installed on a bottom of the main body 1 to support the waste pad p and the plastic bag and to transport the scroll-shaped waste pad p soiled with the excreta and wrapped in the plastic bag to a next position.

The main body 1 is aimed to provide thereon the potty area of a pet using the waste pad p and to accommodate and mount/install therein the constituent devices which automatically cooperate for disposal of the excreta of the pet, and has a sealed installation space 1a for mounting and installing the pad rolling device 2, the bag supplying device 3, the bag opening device 4, and the pad transporting device 5 therein. A waste table 11 having a top opening and having a sufficient area for the pet to stand thereon extends from a side of the main body 1.

At an upper part in the installation space 1a, a container for accommodating the plastic bag roll therein is provided. Preferably, a lid 121 is further provided thereon to easily fill a new plastic bag roll when the accommodated plastic bag roll is used up.

In addition, at an inner corner in the installation space 1a opposite the waste table 11, a drawer-type waste box 13 having an internal space capable of accommodating the scroll-shaped waste pad p wrapped in the plastic bag is further provided.

Preferably, on an external surface of the main body 1, a controller 14 for operating the devices using supplied power and based on user manipulation is further mounted.

The pad rolling device 2 is aimed to dispose of the excreta added on the waste pad p due to elimination of the pet, and is a means for rolling the waste pad p into a scroll shape together with the excreta and disposing of the rolled waste pad p. As illustrated in FIG. 3, the pad rolling device 2 includes a pusher 21 having a plurality of rolling arms 211 used to roll the waste pad p into a scroll shape and bent from opposite sides to face each other with an interval therebetween, and first racks and pinions 22 for vertically lifting ends of the rolling arms 211 at a designated timing in such a manner that the waste pad p is gradually rolled by the pusher 21 along a large orbit not to crush feces on the waste pad p.

From inner sides of the ends of the rolling arms 211 of the pusher 21, projections 211-1 interfering with ends of a side of the waste pad p to gradually roll up the waste pad p protrude by a predetermined length.

The pinions of the first racks and pinions 22, which move linearly, are integrated with protrusion ends of hinge arms 221 protruding from a rotation shaft of the pusher 21.

The bag supplying device 3 is a means for unrolling the plastic bag roll to continuously supply plastic bags to a designated place to wrap the waste pad p rolled into a scroll shape together with the excreta. The bag supplying device 3 includes a plastic bag roll 31 including a plurality of tear-off plastic bags 31-1 joined to one another, an unrolling roller 32 for unrolling an end of the plastic bag roll 31 to continuously supply the plastic bags 31-1 to a designated position, one or more guide rollers 33 for guiding the plastic bags 31-1 unrolled by the unrolling roller 32, toward the bag opening device 4, a plurality of feeding rollers 34 rotating in contact with each other to draw the plastic bags 31-1 guided by the guide rollers 33, to unroll the plastic bag roll 31 and to supply the plastic bags 31-1 toward the bag opening device 4, and a cutter 35 for cutting the plastic bags 31-1 supplied toward the bag opening device 4 by the feeding rollers 34, into a single piece.

The bag opening device 4 is a means for opening a mouth of the single plastic bag 31-1 supplied to the pad transporting device 5 by the bag supplying device 3, in such a manner that the waste pad p rolled into a scroll shape is insertable into the plastic bag 31-1. As illustrated in FIG. 4, the bag opening device 4 includes a lifting roller 41 moved upward in contact with an upper surface of the plastic bag 31-1 to open the mouth of the plastic bag 31-1, by a rotator 411 having ends rotatable upward and downward, and a second rack and pinion 42 for rotating the ends of the rotator 411 upward and downward.

On an external surface of the lifting roller 41, one or more pieces of adhesive tape 410 adherable to a surface of the plastic bag 31-1 are provided at equal intervals.

The pinion of the second rack and pinion 42, which moves linearly, is integrated with a protrusion end of a hinge arm 421 protruding from a rotation shaft of the rotator 411.

The pad transporting device 5 is a means for transporting the waste pad p sequentially toward the pad rolling device 2, the bag opening device 4, and the waste box 13 of the main body 1. The pad transporting device 5 includes a first conveyor 51 for initially transporting the waste pad p placed on the waste table 11, toward the pad rolling device 2 in such a manner that the waste pad p is rolled into a scroll shape by the pad rolling device 2, a hitter for swinging a rotatable end thereof to hit the waste pad p initially transported by the first conveyor 51, in the same moving direction in such a manner that the rolled waste pad p is inserted into the plastic bag 31-1, the mouth of which is opened by the bag opening device 4, and a second conveyor 53 for ultimately transporting the waste pad p wrapped after being inserted into the plastic bag 31-1 by the hitter 52, into the waste box 13.

For reference, a detection sensor (not shown) may be further mounted on an inner wall of the waste table 11 adjacent to ends of the pusher 21, to detect an end of the waste pad p transported by the first conveyor 51, and the first racks and pinions 22 may be operated at a designated timing to lift the ends of the pusher 21 based on the detected signal.

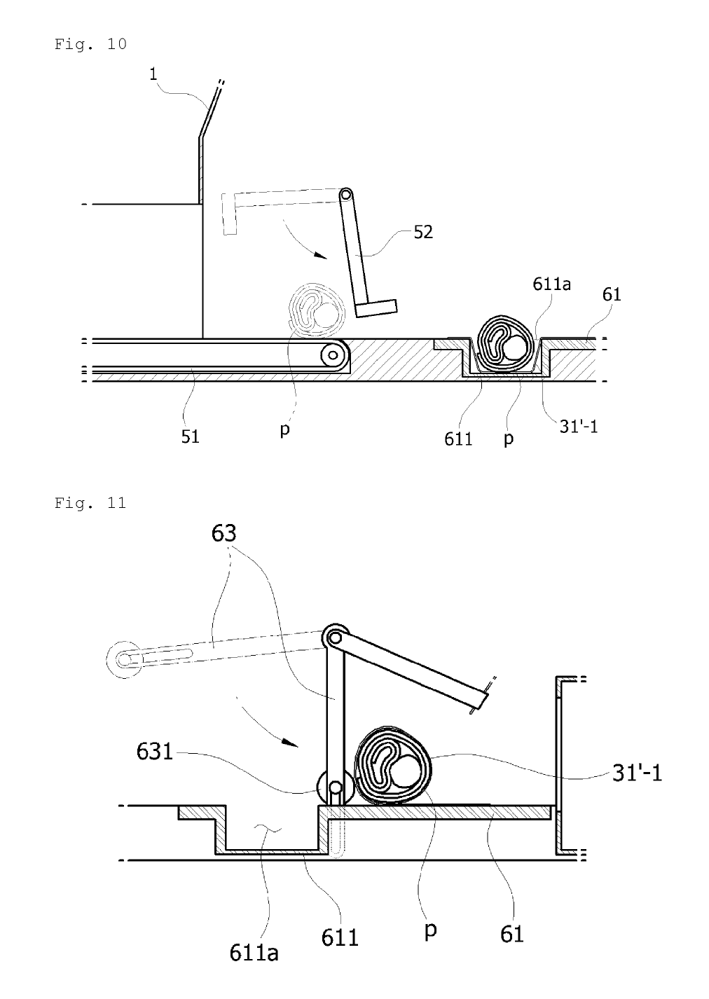

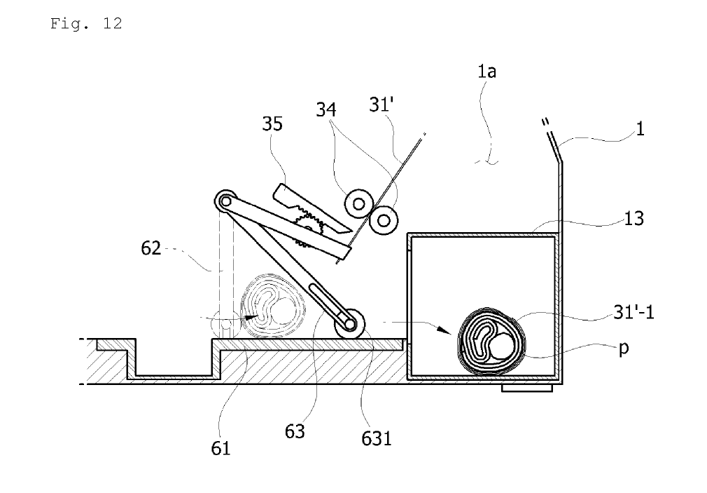

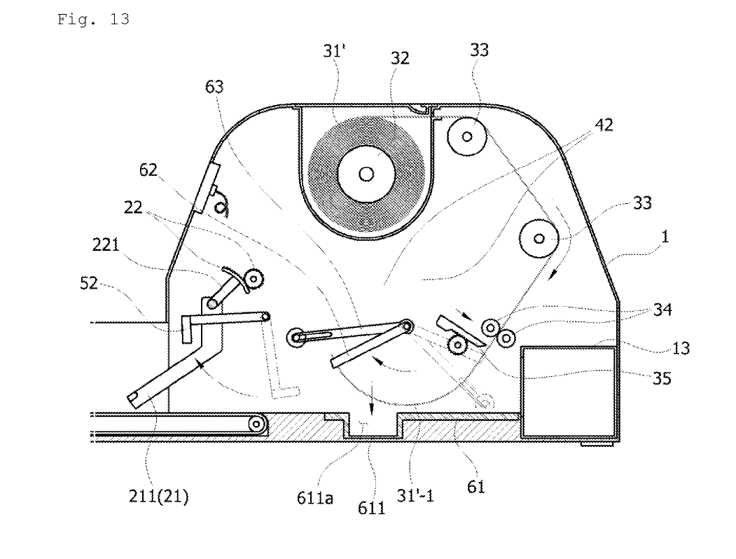

FIG. 9 is a side cross-sectional view showing another embodiment of the pet pet defecation apparatus A according to the present invention, and FIGS. 10 to 13 are cross-sectional views showing operation of the other embodiment of the pet pet defecation apparatus A according to the present invention. Herein, the bag opening device 4 may be omitted and a pad wrapping device 6 capable of performing the function of the bag opening device 4 and a part of the function of the pad transporting device 5 may be added.

Furthermore, instead of the plastic bag roll 31 for supplying the plastic bags 31-1, a plastic wrap roll 31′ including a spool of plastic wrap 31′-1 cuttable to a desired length may be used to wrap the waste pad p.

The above-described pad wrapping device 6 includes an accommodation pad 61 provided on a bottom surface of the main body 1 to prevent slippage of the plastic wrap 31′-1 supplied by the bag supplying device 3, and to accommodate therein the waste pad p rolled into a scroll shape, a drawing member 62 having an end bidirectionally rotatable in the main body 1 to draw an unrolled end of the plastic wrap roll 31′-1 to place the plastic wrap 31′-1 on the accommodation pad 61, and a rotatable arm 63 having a bidirectionally rotatable end to push the plastic wrap 31′-1 placed on the accommodation pad 61 by the drawing member 62, to a side to wrap the waste pad p and then to insert the waste pad p into the waste box 13.

Herein, since the accommodation pad 61 is provided, preferably, the second conveyor 53 of the pad transporting device 5, which is used to ultimately transport the waste pad p toward the waste box 13, is omitted.

At a side of the accommodation pad 61, a downward step 611 for accommodating the waste pad p dropped after being hit by the hitter 52 is provided in a stepped shape. Therefore, a part of the plastic wrap 31′-1 placed on the accommodation pad 61 sags downward to provided a recessed space 611a capable of accommodating the scroll-shaped waste pad p therein.

To the end of the rotatable arm 63, a push wheel 621 capable of wrapping the scroll-shaped waste pad p dropped into the recessed space 611a, with the plastic wrap 31′-1 and easily pushing the waste pad p toward the waste box 13 is coupled.

Operation of the above-described pet defecation apparatus A according to the present invention will now be described in detail. The following description is focused on the structure including the bag opening device 4.

Initially, as illustrated in FIG. 5, when the pet eliminates within the waste table 11, excreta of the pet is dropped on the waste pad p previously placed on the waste table 11.

After the pet eliminates on the waste pad p as described above, a user may drive the pet defecation apparatus A of the present invention to start an operation for disposing of the excreta, by manipulating the controller 14.

As such, a belt of the first conveyor 51 of the pad transporting device 5 starts to rotate in a direction, the waste pad p is initially transported toward the pad rolling device 2 and is gradually rolled up due to interference of the projections 211-1 protruding inward from the ends of the rolling arms 211 of the pusher 21, and the above-described operation is continued to roll the waste pad pinto a scroll shape.

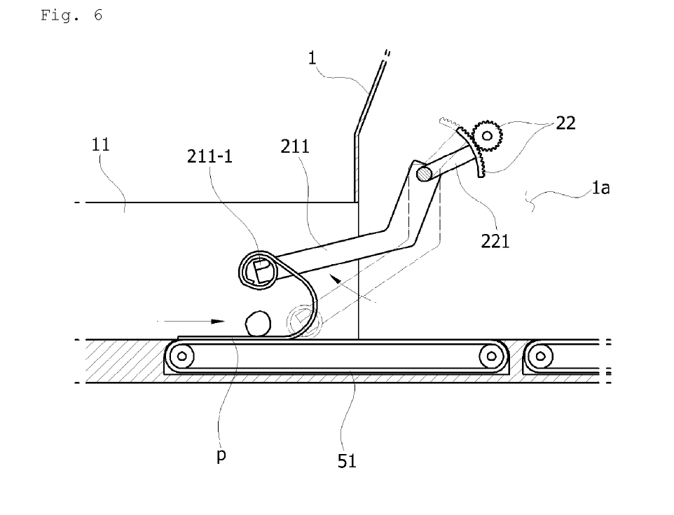

In this case, as illustrated in FIG. 6, the first racks and pinions 22 may be operated at a designated time by a preset program to rotate the ends of the rolling arms 211 upward, and thus a part of the waste pad p may be rolled along a large orbit not to crush the excreta on the waste pad p but to wrap the excreta with the waste pad p.

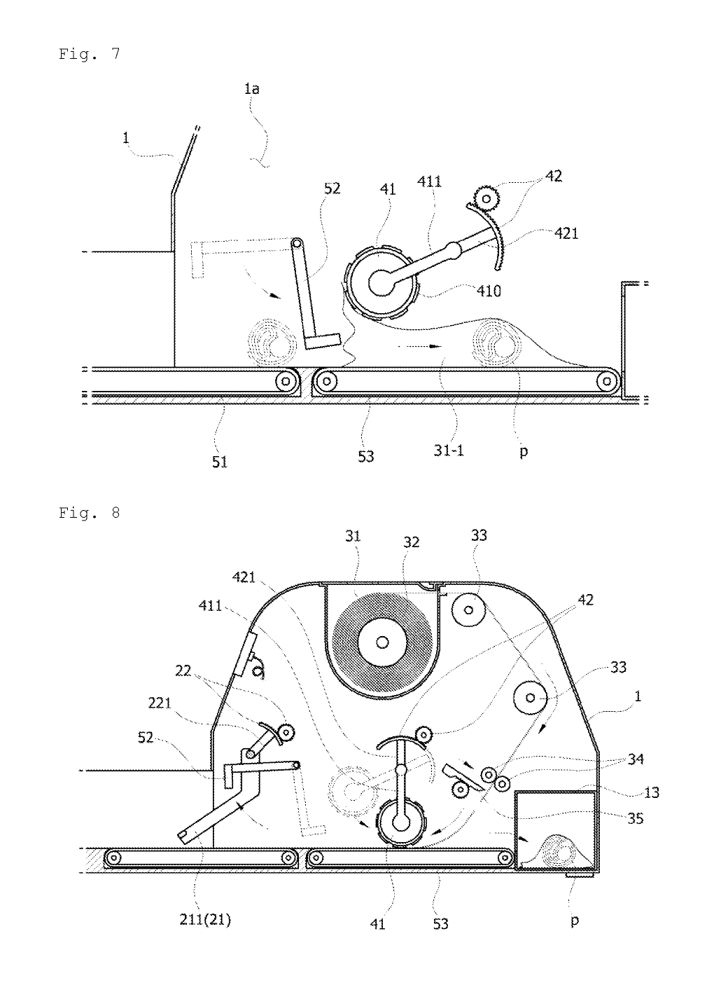

Then, as illustrated in FIG. 7, the waste pad p including the excreta and rolled into a scroll shape is moved toward the bag opening device 4 by the hitter 52, and thus may be inserted into the plastic bag 31-1, the mouth of which is opened by the lifting roller 41 of the bag opening device 4. Then, the waste pad p may be continuously moved in the same moving direction by the second conveyor 53 of the pad transporting device 5, and may be ultimately accommodated in the waste box 13.

As such, after the waste pad p wrapped in the plastic bag 31-1 is accommodated in the waste box 13, the waste box 13 may be easily taken out of the main body 1 and the waste pad p may be ultimately thrown into a waste bin such as a trash can, thereby completing disposal of the excreta.

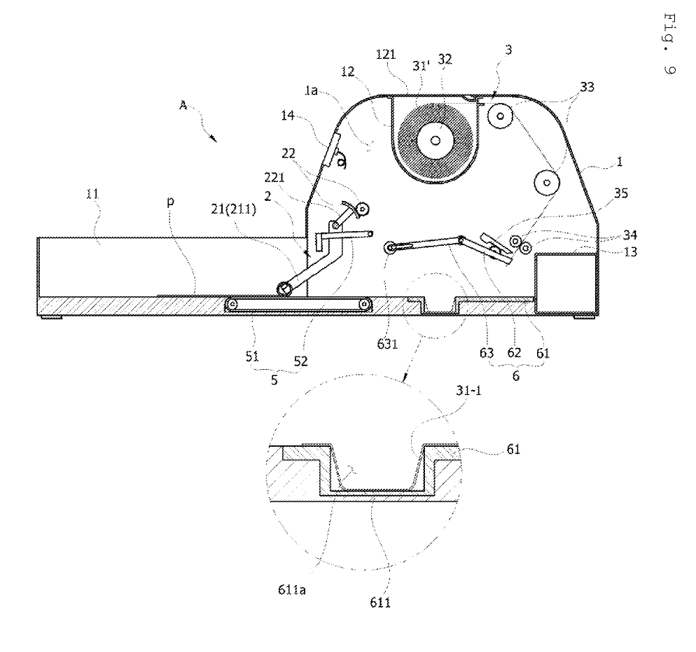

Lastly, as illustrated in FIG. 8, since the plastic bags 31-1 are supplied from the plastic bag roll 31 due to operation of the feeding rollers 34 of the bag supplying device 3, a single plastic bag 31-1 is cut due to operation of the cutter 35 and then is placed on the second conveyor 53 of the pad transporting device 5. After that, the user manually places a new waste pad p on the waste table 11 and fixes two ends of a side of the waste pad p to the pusher 21, thereby preparing for next elimination of the pet and driving of the pet defecation apparatus A for disposal of excreta.

In summary, due to cooperation of the pad rolling device 2, the bag supplying device 3, the bag opening device 4, and the pad transporting device 5, disposal of excreta of a pet may be enabled without manual handling of a user and thus the user may concentrate on living together with the pet without being bothered about disposal of the excreta.

In addition, since easy disposal of the excreta is enabled using the above-described pet defecation apparatus A of the present invention, odors and germs caused when disposal of the excreta is not immediately performed may be completely solved and thus a clean indoor living environment may be easily achieved.

While the present invention has been particularly shown and described with reference to embodiments thereof, it will be understood by one of ordinary skill in the art that various changes in form and details may be made therein without departing from the spirit and scope of the present invention as defined by the following claims.

### INDUSTRIAL APPLICABILITY

According to a pet defecation apparatus of the present invention, efficiency of disposal of excreta may be increased and odors of the excreta may be prevented, thereby easily achieving a clean indoor living environment. In addition, the above advantages may encourage people to purchase products and thus the pet-related industry may be greatly developed and vitalized.

1. A pet defecation apparatus comprising:
a main body for holding a waste pad to provide a potty area and enabling cooperative internal-external installation of constituent devices;
a pad rolling device mounted in the main body to roll the waste pad soiled with excreta, into a scroll shape;
a bag supplying device mounted in the main body to unroll a plastic bag roll to supply a plastic bag for wrapping the waste pad rolled by the pad rolling device, to a designated position;
a bag opening device mounted in the main body to open a mouth of the plastic bag provided by the bag supplying device, in such a manner that the waste pad is insertable into the plastic bag; and
a pad transporting device installed on a bottom of the main body to support the waste pad and the plastic bag and to transport the scroll-shaped waste pad wrapped in the plastic bag to a next position.

2. A pet defecation apparatus comprising:
a main body for holding a waste pad to provide a potty area and enabling cooperative internal-external installation of constituent devices;
a pad rolling device mounted in the main body to roll the waste pad soiled with excreta, into a scroll shape;
a bag supplying device mounted in the main body to unroll a plastic wrap roll to supply plastic wrap for wrapping the waste pad rolled by the pad rolling device, to a designated position;
a pad wrapping device mounted in the main body to draw the plastic wrap supplied from the bag supplying device to place the plastic wrap at a designated position, and to wrap the scroll-shaped waste pad with the plastic wrap to transport the waste pad to a next position; and
a pad transporting device installed on a bottom of the main body to support the waste pad and to transport the scroll-shaped waste pad to a next position.

3. The pet defecation apparatus according to any one of claims 1 and 2, wherein the main body has a sealed installation space for mounting and installing the constituent devices therein, and
Wherein a waste table having a top opening and having a sufficient area for a pet to stand thereon extends from a side of the main body.

4. The pet defecation apparatus according to any one of claims 1 and 2, wherein the pad rolling device comprises:
a pusher having a plurality of rolling arms used to roll the waste pad into a scroll shape and bent from opposite sides to face each other with an interval therebetween; and
first racks and pinions for vertically lifting ends of the rolling arms at a designated timing in such a manner that the waste pad is gradually rolled by the pusher along a large orbit not to crush feces on the waste pad.

5. The pet defecation apparatus according to any one of claims 1 and 2, wherein the bag supplying device comprises:
A plastic bag roll or a plastic wrap roll comprising a plurality of tear-off plastic bags or a spool of plastic wrap;
an unrolling roller for unrolling an end of the plastic bag roll or the plastic wrap roll to continuously supply the plastic bags or the plastic wrap to a designated position;
one or more guide rollers for guiding the plastic bags or the plastic wrap unrolled by the unrolling roller, toward the bag opening device or the pad wrapping device;
a plurality of feeding rollers rotating in contact with each other to draw the plastic bags or the plastic wrap guided by the guide rollers, to unroll the plastic bag roll or the plastic wrap roll and to supply the plastic bags or the plastic wrap toward the bag opening device or the pad wrapping device; and
a cutter for cutting the plastic bags or the plastic wrap supplied toward the bag opening device or the pad wrapping device by the feeding rollers, into a single piece.

6. The pet defecation apparatus according to any one of claims 1 and 2, wherein a container for accommodating the plastic bag roll or the plastic wrap roll therein is provided at an upper part in the main body, and a drawer-type waste box having an internal space capable of accommodating the scroll-shaped waste pad wrapped in the plastic bag or with the plastic wrap is further provided at an inner corner in the main body.

7. The pet defecation apparatus according to claim 1, wherein the bag opening device comprises:
a lifting roller moved upward and downward in contact with an upper surface of the plastic bag to open the mouth of the plastic bag, by a rotator having ends rotatable upward and downward; and
a second rack and pinion for rotating the ends of the rotator upward and downward.

8. The pet defecation apparatus according to claim 1, wherein the pad transporting device comprises:
a first conveyor for initially transporting the waste pad placed on the waste table, toward the pad rolling device in such a manner that the waste pad is rolled into a scroll shape by the pad rolling device;
a hitter for swinging a rotatable end thereof to hit the waste pad initially transported by the first conveyor, in the same moving direction to further transport the waste pad; and
a second conveyor for ultimately transporting the waste pad wrapped after being inserted into the plastic bag by the hitter, into the waste box.

9. The pet defecation apparatus according to claim 2, wherein the pad transporting device comprises:
a first conveyor for initially transporting the waste pad placed on the waste table, toward the pad rolling device in such a manner that the waste pad is rolled into a scroll shape by the pad rolling device; and
a hitter for swinging a rotatable end thereof to hit the waste pad initially transported by the first conveyor, in the same moving direction to further transport the waste pad.

10. The pet defecation apparatus according to claim 2, wherein the pad wrapping device comprises:
an accommodation pad provided on a bottom surface of the main body to prevent slippage of the plastic wrap supplied by the bag supplying device, and to accommodate therein the waste pad rolled into a scroll shape;
a drawing member having an end bidirectionally rotatable in the main body to draw an unrolled end of the plastic wrap roll to place the plastic wrap on the accommodation pad; and
a rotatable arm having a bidirectionally rotatable end to push the plastic wrap placed on the accommodation pad by the drawing member, to a side to wrap the waste pad and then to insert the waste pad into the waste box.

11. The pet defecation apparatus according to claim 4, wherein projections interfering with ends of a side of the waste pad to gradually roll up the waste pad protrude by a predetermined length from inner sides of the ends of the rolling arms.

12. The pet defecation apparatus according to claim 7, wherein one or more pieces of adhesive tape adherable to a surface of the plastic bag are provided at equal intervals on an external surface of the lifting roller.

13. The pet defecation apparatus according to claim 10, wherein a downward step for accommodating the waste pad dropped after being further transported by the hitter is provided in a stepped shape at a side of the accommodation pad such that a part of the plastic wrap placed on the accommodation pad sags downward to provide a recessed space capable of accommodating the scroll-shaped waste pad therein.

14. The pet defecation apparatus according to claim 10, wherein a push wheel capable of wrapping the scroll-shaped waste pad with the plastic wrap and pushing the waste pad toward the waste box is coupled to the end of the rotatable arm.
